(19) United States
(12) Patent Application Publication
(10) Pub. No.: US 2026/0368256 A1
(43) Pub. Date: Nov. 19, 2026

(54) MULTI-AGENT AI FRAMEWORK DATA EXTRACTION

(71) Applicant: BP Corporation North America Inc., Houston, TX (US)

(72) Inventors: Aishwarya PADHI, Pune (IN); Subhendu MISHRA, Pune (IN)

(73) Assignee: BP Corporation North America Inc., Houston, TX (US)

(21) Appl. No.: 19/679,276

(22) Filed: May 15, 2026

(30) Foreign Application Priority Data
May 16, 2025 (IN) 202511047489

(51) Int. Cl. G06F 16/9032

(52) U.S. Cl. CPC G06F 16/90332

(57) ABSTRACT

In some examples, a computer-implemented method includes receiving, at a proxy agent, user input from a user. The method also includes providing, by the proxy agent to a prompt generation agent, the user input. The method also includes generating, by the prompt generation agent, a prompt for querying a data set based on the user input. The method also includes providing, by the prompt generation agent to the proxy agent, the prompt. The method also includes determining modifications to the prompt. The method also includes modifying, by the prompt generation agent, the prompt according to the modifications to form a modified prompt. The method also includes providing, by the proxy agent, the modified prompt to a data extraction agent. The method also includes extracting, by the data extraction agent, data from the data set according to instructions of the prompt.

### CROSS-REFERENCE TO RELATED APPLICATIONS

This application claims priority to Indian patent application serial number 202511047489 filed May 16, 2025, and entitled “Multi-Agent AI Framework Data Extraction,” which is hereby incorporated herein by reference in its entirety for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In the modern connected age, an enterprise may process a lot of structured and/or unstructured documents. Common formats include office documents (e.g., text files, spreadsheets or tables, presentation slide decks, etc.), binary documents (image or other files), and the like. Often, the volume of available data along with the variance of document formats and layouts, whether structured or unstructured, makes managing the data or deriving insights from the data challenging.

### SUMMARY

In some examples, a system includes one or more processors and a memory including a plurality of computer-executable components that are executable by the one or more processors to perform a plurality of actions. The plurality of actions include receiving, at a proxy agent, user input from a user. The plurality of actions also include providing, by the proxy agent to a prompt generation agent, the user input. The plurality of actions also include generating, by the prompt generation agent, a prompt for querying a data set based on the user input. The plurality of actions also include providing, by the prompt generation agent via the proxy agent, the prompt to a critic agent, the critic agent a non-human system. The plurality of actions also include determining, via the critic agent, modifications to the prompt. The plurality of actions also include modifying, by the prompt generation agent, the prompt according to the modifications to form a modified prompt. The plurality of actions also include providing, by the proxy agent, the modified prompt to a data extraction agent. The plurality of actions also include extracting, by the data extraction agent, data from the data set according to instructions of the prompt to form extracted data.

In some examples, the disclosure includes one or more non-transitory computer-readable media, storing computer-executable instructions that upon execution cause one or more processors to perform acts comprising receiving, at a proxy agent, user input from a user, providing, by the proxy agent to a prompt generation agent, the user input, generating, by the prompt generation agent, a prompt for querying a data set based on the user input, providing, by the prompt generation agent to the proxy agent, the prompt, determining modifications to the prompt, modifying, by the prompt generation agent, the prompt according to the modifications to form a modified prompt, providing, by the proxy agent, the modified prompt to a data extraction agent, and extracting, by the data extraction agent, data from the data set according to instructions of the prompt.

In some examples, a computer-implemented method includes receiving, at a proxy agent, user input from a user. The method also includes providing, by the proxy agent to a prompt generation agent, the user input. The method also includes generating, by the prompt generation agent, a prompt for querying a data set based on the user input. The method also includes providing, by the prompt generation agent to the proxy agent, the prompt. The method also includes determining modifications to the prompt. The method also includes modifying, by the prompt generation agent, the prompt according to the modifications to form a modified prompt. The method also includes providing, by the proxy agent, the modified prompt to a data extraction agent. The method also includes extracting, by the data extraction agent, data from the data set according to instructions of the prompt.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an example of the disclosure.

FIG. 2 is a flow chart of a method according to an example of the disclosure.

FIG. 3 is a block diagram of a computer system according to an example of the disclosure.

### DETAILED DESCRIPTION

It should be understood at the outset that although illustrative implementations of one or more examples are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The disclosure teaches approaches for automatically and intelligently managing large volumes of data (e.g., “big data”). As noted above, in the modern connected age, an enterprise may process a lot of structured and/or unstructured documents. Common formats include office documents (e.g., text files, spreadsheets or tables, presentation slide decks, etc.), binary documents (image or other files), and the like. Often, the volume of available data along with the variance of document formats and layouts, whether structured or unstructured, makes managing the data or deriving insights from the data challenging. Existing processes may be semi-automated, requiring human user expertise and input to create extensive prompts as input to data management systems, software for managing the data, etc. The prompt generation may require considerable expertise of the human user and understanding of the engineering of prompt generation. Even so, the data management systems will often undergo multiple iterations of analyzing the data given a prompt before an expected or desired output or result is achieved. This iterative approach expends greater amounts of processing capabilities, thereby preventing other processing from being performed, as well as power and time.

Improvements including at least efficiency can be achieved in the technological field of big data and big data management or analysis, as well as in the energy consumption and processor usage of systems performing the big data management or analysis. Improvements can further be achieved in an accuracy of output of the systems performing the big data management or analysis. To achieve these improvements, a process of obtaining useful or desired data insights from big data may be automated. A user may initiate a big data analysis operation by providing a general intent. This general intent may be broad, such as a desire to obtain tabular data, obtain tabular data related to a particular subject, or the like. The general intent may not be in a format suitable for use as a prompt for analyzing or querying the big data and may generally be conversational or plain-language.

Based on the received intent, a multi-agent big data analysis system automatically generates a prompt to query or analyze the big data to achieve a user’s goal as expressed by the intent. For example, the data analysis system includes multiple large language model (LLM) agents. A LLM agent is an artificial intelligence or machine learning system that is specialized for a particular purpose. In some examples, at least some of the LLM agents are multimodal agents. LLM agents can learn based on prior interactions, predict or think ahead, and can be tuned to particular uses. For example, an LLM agent can be instructed to take on a particular persona or role, thereby increasing performance of the LLM agent with respect to tasks related to that persona or role. For example, an LLM agent may be capable of analyzing data, such as a generated prompt, and returning an opinion or recommendation related to the data. However, an LLM agent tasked with the persona or role of being a critic may provide increased performance in critical analysis tasks, such as analyzing data and returning an opinion or recommendation related to the data. For example, a critic agent may critique a prompt for querying data, providing a recommendation for modification to modify what results may be provided responsive to the prompt. Other LLM agents can include a proxy agent tasked with the persona of a mediator or facilitator, a prompt generation agent tasked with the persona of a prompt generator, a data extraction agent tasked with the personal tasked with the persona of a data extractor, and the like. Thus, by tasking the LLM agents with particular personas, the data analysis system improves performance of the LLM agents with respect to tasks related to their assigned personas. While certain LLM agents are considered and described herein, the data analysis system may be extended (e.g., scalable) to include any other LLM agents suitable for performing tasks that may be useful in the data analysis system.

In some examples, a proxy agent receives the general intent from the human user. In some examples, the proxy agent may also receive an indication of a document class associated with the general intent. The proxy agent initiates communication with a prompt generation agent and automatically constructs a request or instruction based on the received general intent and class. The request or instruction causes the prompt generation agent to generate a prompt for querying a data base to obtain information determined to be responsive to the general intent. Responsive to receiving the request or instruction from the proxy agent, the prompt generation agent automatically generates the prompt for querying a data base. The prompt may be generated without user input to the prompt beyond that provided by the user to the proxy agent in the general intent of the user. In this way, the prompt may be generated without specialized or extensive prompt generation knowledge of the user and without multiple iterative queries of the data base to tailor the prompt. Responsive to generating the prompt, the prompt generation agent provides the prompt to the proxy agent which, optionally, may provide the prompt to the user for review and feedback. If feedback is received from the user, the proxy agent provides the feedback to the prompt generation agent for modifying the prompt and, in some examples, refining training of (e.g., retraining) the prompt generation agent to improve the quality of prompts subsequently generated by the prompt generation agent.

If feedback is not received from the user, or the proxy agent does not the prompt the user for feedback, the proxy agent provides the prompt to a critic agent. The critic agent is tasked with a persona of an expert in or critic of prompt generation. Accordingly, the critic agent examines the prompt critically and, if the critic agent determines comments or feedback on the prompt, provides feedback on the prompt to the proxy agent. The proxy agent may provide the feedback received from the critic agent to the prompt generation agent for modifying the prompt and, in some examples, refining training of (e.g., retraining) the prompt generation agent to improve the quality of prompts subsequently generated by the prompt generation agent. This iterative process of prompt generation, feedback solicitation, and prompt refinement may be performed any suitable number of times, the scope of which is not limited herein. For example, a user may specify a number of iterations, a preset number of iterations may be performed, or the like. At a conclusion of the iterative prompt generation and revision process, the proxy agent subsequently provides the modified prompt to a data extraction agent. In some examples, the proxy agent may also obtain raw data (e.g., data from the data base, data from the user, etc.) and provide the raw data to the data extraction agent. In other examples, the data extraction agent itself obtains the raw data directly (e.g., data from the data base, data from the user, etc.).

In an example, the data extraction agent analyzes the raw data based on the prompt to determine an output. For example, responsive to the prompt, the data extraction agent extracts a portion of the raw data to form extracted data. In some examples, the extracted data may be provided to another LLM agent or component that processes or formats the extracted data. In other examples, the data extraction agent provides the extracted data in a formatted manner. The extracted data may subsequently be provided to the user, either by the proxy agent which receives the extracted data from the data extraction agent, from data extraction agent, or from another component that processes or formats the extracted data. In some examples, the extracted data is provided to a data base to be stored for subsequent access and/or manipulation.

In various examples, the extracted data, further processed data based on the extracted data, or control signals determined based on the extracted data, may be provided to a physical device for controlling the device. For example, based on the extracted data, a valve or other pressure release value may be controlled to open or close, a speed of a drill or other device may be modified, a geographic location of a device may be modified, or the like. In various examples, visualizations such as charts, graphs, animations, or the like may be generated based on the extracted data or the further processed data based on the extracted data. In some examples, such generation may be performed automatically subsequent to the data extraction and without additional human intervention to create the visualizations from the data. In some examples, the extracted data or the further processed data based on the extracted data may be provided to a machine learning model to train the machine learning model, or as input to a machine learning model, such as to cause the machine learning model to provide a prediction based on the extracted data or the further processed data based on the extracted data.

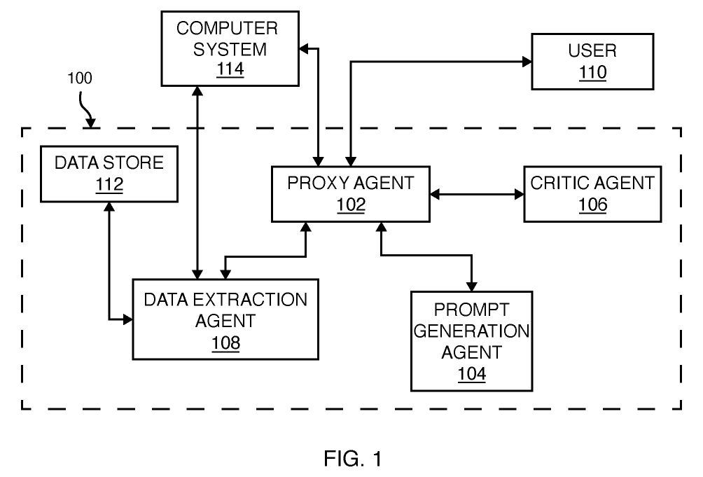

FIG. 1 is a block diagram of a system 100 according to an example of the disclosure. In some examples, the system 100 includes a proxy agent 102, a prompt generation agent 104, a critic agent 106, and a data extraction agent 108, each as described above herein. In some examples, each of the proxy agent 102, prompt generation agent 104, critic agent 106, and data extraction agent 108 may be implemented by respective computer systems, such as described below herein. In other examples, any one or more of the proxy agent 102, prompt generation agent 104, critic agent 106, or data extraction agent 108 may be implemented by a respective computer system, with other of the proxy agent 102, prompt generation agent 104, critic agent 106, or data extraction agent 108 implemented by another, or multiple other, computer systems.

As described above, each of the proxy agent 102, prompt generation agent 104, critic agent 106, and data extraction agent 108 is an LLM agent. In some examples, each of the proxy agent 102, prompt generation agent 104, critic agent 106, and data extraction agent 108 operates according to a same LLM. In other examples, any one or more of the proxy agent 102, prompt generation agent 104, critic agent 106, or data extraction agent 108 operates according to any suitable LLM, the scope of which is not limited herein. Some examples of suitable LLMs include LLMs from OpenAI, such as GPT-4, GPT4-V, GPT-3.5 etc., Falcon, Llama, or the like. In various examples, some LLMs may be more suitable for implementation as certain agents than other LLMs. For example, a more robust or complex LLM, a multimodal LLM, or the like may be implemented for any one or more of the proxy agent 102, prompt generation agent 104, critic agent 106, or data extraction agent 108. In that example, a less robust or complex LLM, such as a LLM that is not multimodal, may be implemented for any one or more other of the proxy agent 102, prompt generation agent 104, critic agent 106, or data extraction agent 108. For example, the critic agent 106 may be implemented as a more robust LLM and the proxy agent 102 may be implemented as a less robust LLM. In this way, processing efficiencies may be gained by using a right-sized LLM for a particular agent.

In an example, a user 110 initiates a data extraction process of the system 100 by providing user input to the proxy agent 102. In some examples, the user input has a conversational or plain language format. Generally, the user input lacks a syntax, format, or content understandable by or sufficient for the data extraction agent 108 to extract data from a data set responsive to the user input. The proxy agent 102 receives the user input from the user 110 and provides the user input to the prompt generation agent 104. Responsive to receiving the user input from the proxy agent 102, the prompt generation agent 104 parses the user input and generates a prompt for querying a data set to achieve a goal or intent expressed by the user input. Responsive to generating the prompt, the prompt generation agent 104 provides the prompt to the proxy agent 102.

In a first example, the proxy agent 102 provides the prompt received from the prompt generation agent 104 to the user 110. For example, the proxy agent 102 may provide the prompt to the user 110 to solicit feedback, critique, or revision by the user 110. If feedback is received from the user 110, the proxy agent 102 may provide the feedback to the prompt generation agent 104 for modifying the prompt and, in some examples, refining training of (e.g., retraining) the prompt generation agent 104 to improve the quality of prompts subsequently generated by the prompt generation agent 104. In other examples, the proxy agent 102 may itself modify the prompt. The proxy agent 102 may subsequently provide the modified prompt to the data extraction agent 108.

In a second example, the proxy agent 102 provides the prompt received from the prompt generation agent 104 to the critic agent 106. In some implementations, the second example follows the first example (e.g., both the user 110 and critic agent 106 are solicited for feedback sequentially). In other implementations, the second example is performed in place of the first example (e.g., the critic agent 106, but not the user 110, is solicited for feedback). For example, the proxy agent 102 may provide the prompt to the critic agent 106 to solicit feedback, critique, or revision by the user 110. In various examples, the feedback may indicate whether the prompt considers data granularity, whether the prompt includes sufficient instructions to distinguish between variations in attributes of data (e.g., a attribute for "Depth" measurement could be subdivided into "measured depth" and "true depth"), whether the prompt has bugs that could lead to inaccurate data extraction, etc. If feedback is received from the critic agent 106, the proxy agent 102 may provide the feedback to the prompt generation agent 104 for modifying the prompt and, in some examples, refining training of (e.g., retraining) the prompt generation agent 104 to improve the quality of prompts subsequently generated by the prompt generation agent 104. In other examples, the proxy agent 102 may itself modify the prompt. The proxy agent 102 may subsequently provide the modified prompt to the data extraction agent 108.

The data extraction agent 108 receives the modified prompt and extracts data from a data set responsive to the modified prompt to provide extracted data. In some examples, the data extraction agent 108 retrieves or accesses the data set, or a portion of the data set, from a data store 112. In other examples, the proxy agent 102 retrieves or accesses the data set, or a portion of the data set, from a data store 112 and provides the data set or portion of the data set to the data extraction agent 108. In yet other examples, the data extraction agent 108 receives the data set from the user 110 directly or through the proxy agent 102. The data set may include any form of data, either structure or unstructured, and in any format. For example, the data set may include data in a portable document format (PDF), images, videos, audio, word processing (e.g., text documents), charts, tables, or the like. In some examples, the data set includes information related to reports, such as seismic reports, chemical reports, oil pipeline reports, etc. In some examples, the data extraction agent 108 provides the extracted data to the data store 112 for storage, either directly or through the proxy agent 102. In other examples, the data extraction agent 108 provides the extracted data to the user 110 for storage, either directly or through the proxy agent 102.

In yet other examples, the data extraction agent 108 provides the extracted data to a computer system 114, either directly or through the proxy agent 102, for processing or other manipulation. For example, the computer system 114 may format the extracted data, manipulate the extracted data (e.g., filter, normalize, sort, or other otherwise determine derivative data from the extracted data), or perform any other task based on the extracted data. In some examples, the system 100 may control a second system (not shown) according to the extracted data.

In some examples, the computer system 114 is a same device which implements one or more of the proxy agent 102, prompt generation agent 104, critic agent 106, or data extraction agent 108. For example, based on the extracted data, a valve or other pressure release value may be controller to open or close, a speed of a drill or other device may be modified, a geographic location of a device may be modified, or the like.

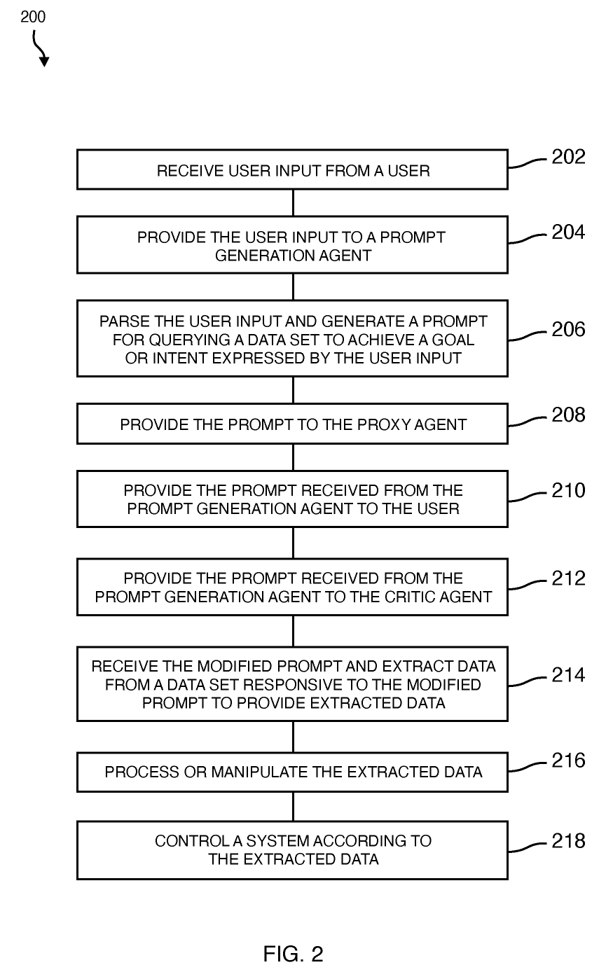

FIG. 2 is a flow chart of a method 200 according to an example of the disclosure. In some examples, the method 200 is a method of automatically and intelligently managing large volumes of data (e.g., “big data”). For example, the method 200 may be implemented by one or more artificial intelligence or machine learning systems, or computer systems that implement artificial intelligence or machine learning processing.

At operation 202, a proxy agent receives user input from a user. In some examples, the user input has a conversational or plain language format. Generally, the user input lacks a syntax, format, or content understandable by or sufficient for a data extraction agent to extract data from a data set responsive to the user input.

At operation 204, the proxy agent provides the user input to a prompt generation agent. At operation 206, the prompt generation agent parses the user input and generates a prompt for querying a data set to achieve a goal or intent expressed by the user input. In an example, the prompt is in a syntax, format, or includes content(s) different from the user input but derived at least in part from the intent expressed by the user input. At operation 208, the prompt generation agent provides the generated prompt to the proxy agent.

At operation 210, the proxy agent provides the prompt received from the prompt generation agent to the user. For example, the proxy agent may provide the prompt to the user to solicit feedback, critique, or revision by the user. If feedback is received from the user, the proxy agent may provide the feedback to the prompt generation agent for modifying the prompt and, in some examples, refining training of (e.g., retraining) the prompt generation agent to improve the quality of prompts subsequently generated by the prompt generation agent. In other examples, the proxy agent may itself modify the prompt. The proxy agent may subsequently provide the modified prompt to the data extraction agent.

At operation 212, the proxy agent provides the prompt received from the prompt generation agent to the critic agent. In some examples, operation 212 follows operation 210 (e.g., both the user and critic agent are solicited for feedback sequentially). In other examples, operation 212 is performed in place of operation 210 (e.g., operation 210 is omitted and not performed such that the critic agent, but not the user, is solicited for feedback). For example, the proxy agent may provide the prompt to the critic agent to solicit feedback, critique, or revision by the critic agent. If feedback is received from the critic agent, the proxy agent may provide the feedback to the prompt generation agent for modifying the prompt and, in some examples, refining training of (e.g., retraining) the prompt generation agent to improve the quality of prompts subsequently generated by the prompt generation agent. The proxy agent may subsequently provide the modified prompt to the data extraction agent.

At operation 214, the data extraction agent receives the modified prompt and extracts data from a data set responsive to the modified prompt to provide extracted data. In some examples, the data extraction agent retrieves or accesses the data set, or a portion of the data set, from a data store. In other examples, the proxy agent retrieves or accesses the data set, or a portion of the data set, from a data store and provides the data set or portion of the data set to the data extraction agent. In yet other examples, the data extraction agent receives the data set from the user directly or through the proxy agent. In some examples, the data extraction agent provides the extracted data to the data store for storage, either directly or through the proxy agent. In other examples, the data extraction agent provides the extracted data to the user for storage, either directly or through the proxy agent.

At operation 216, the extracted data is processed or otherwise manipulated. For example, a computer system may format the extracted data, manipulate the extracted data (e.g., filter, normalize, sort, or other otherwise determine derivative data from the extracted data), or perform any other task based on the extracted data.

At operation 218, a system is controlled according to the extracted data. In some examples, the control may be based on the extracted data or based on control signals determined or otherwise derived from the extracted data. For example, based on the extracted data, a valve or other pressure release value may be controlled to open or close, a speed of a drill or other device may be modified, a geographic location of a device may be modified, or the like.

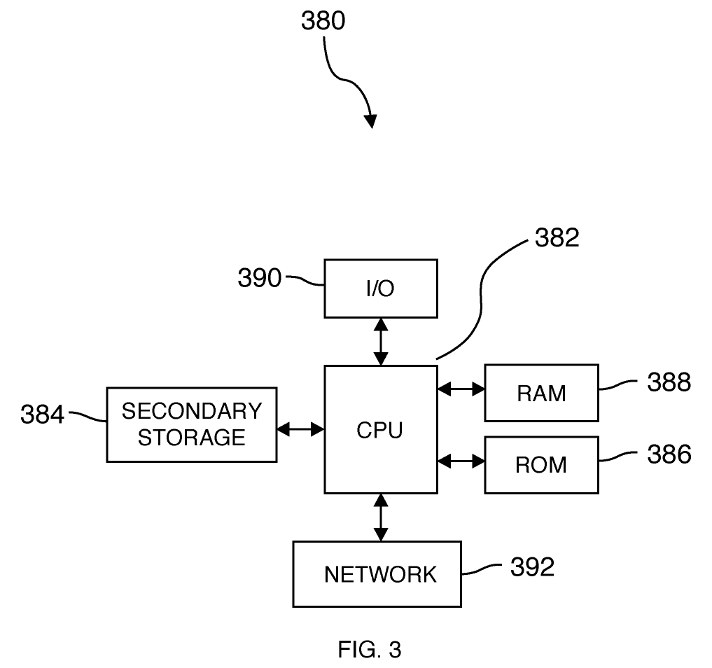

FIG. 3 illustrates a computer system 380 suitable for implementing one or more examples disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips and/or may me a multi-core processor.

By programming and/or loading executable instructions onto the computer system 380, at least one of the CPU 382, the RAM 388, and the ROM 386 are changed, transforming the computer system 380 in part into a particular machine or apparatus having the functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions which comprise the application. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that comprise the application. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the functionality taught by the present disclosure. When the CPU 382 is configured in this way by the application, the CPU 382 becomes a specific purpose computer or a specific purpose machine.

The secondary storage 384 typically comprises one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may be referred to as physical interfaces or physical network interfaces. The network connectivity devices 392 may take the form of modems, modem banks, Ethernet cards, universal serial bus (USB) interface cards, serial interfaces, token ring cards, fiber distributed data interface (FDDI) cards, WLAN cards such as a WiFi physical interface, radio transceiver cards such as a WWAN (e.g., a cellular network physical interface), and/or other network devices. A network connectivity device 392 may comprise an Ethernet-to-satellite wireless link physical interface. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an example, the radio transceiver cards may provide wireless communication links using protocols such as CDMA, GSM, LTE, WiFi (IEEE 802.11), Bluetooth, Zigbee, NB IoT, NFC, RFID. The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and transmitted to the network, for example, in the form of a computer data baseband signal or signal embodied in a carrier wave. The baseband signal or signal embedded in the carrier wave, or other types of signals currently used or hereafter developed, may be generated according to any suitable methods. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors or processor cores may be present. Thus, while instructions may be discussed as executed by a processor, the instructions may be executed simultaneously, serially, or otherwise executed by one or multiple processors or processor cores. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an example, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an example, virtualization software may be employed by the computer system 380 to provide the functionality of a number of servers that is not directly bound to the number of computers in the computer system 380. For example, virtualization software may provide twenty virtual servers on four physical computers. In an example, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an example, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM example of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several examples have been provided in the present disclosure, the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various examples as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system, comprising:
one or more processors; and
memory including a plurality of computer-executable components that are executable by the one or more processors to perform a plurality of actions, the plurality of actions comprising:
receiving, at a proxy agent, user input from a user;
providing, by the proxy agent to a prompt generation agent, the user input;
generating, by the prompt generation agent, a prompt for querying a data set based on the user input;
providing, by the prompt generation agent via the proxy agent, the prompt to a critic agent, the critic agent a non-human system;
determining, via the critic agent, modifications to the prompt;
modifying, by the prompt generation agent, the prompt according to the modifications to form a modified prompt;
providing, by the proxy agent, the modified prompt to a data extraction agent; and
extracting, by the data extraction agent, data from the data set according to instructions of the prompt to form extracted data.

2. The system of claim 1, wherein the proxy agent, the prompt generation agent, the critic agent, and the data extraction agent are each large language model (LLM) agents.

3. The system of claim 1, wherein the user input is a plain language input lacking syntax and formatting of the prompt.

4. The system of claim 1, wherein determining the modifications to the prompt includes:
analyzing, by the critic agent, the prompt to determine modification recommendations for the prompt; and
providing, by the critic agent to the proxy agent, the modification recommendations for the prompt.

5. The system of claim 1, wherein determining the modifications to the prompt includes:
providing, by the proxy agent to the user, the prompt; and
receiving, by the proxy agent, the modification recommendations for the prompt.

6. The system of claim 1, wherein the plurality of actions further comprises:
processing the extracted to manipulate the extracted data to form processed data; and
controlling a physical process according to the processed data.

7. The system of claim 1, wherein the proxy agent comprises a first large language model and the critic agent comprises a second large language model.

8. One or more non-transitory computer-readable media, storing computer-executable instructions that upon execution cause one or more processors to perform acts comprising:
receiving, at a proxy agent, user input from a user;
providing, by the proxy agent to a prompt generation agent, the user input;
generating, by the prompt generation agent, a prompt for querying a data set based on the user input;
providing, by the prompt generation agent to the proxy agent, the prompt;
determining modifications to the prompt;
modifying, by the prompt generation agent, the prompt according to the modifications to form a modified prompt;
providing, by the proxy agent, the modified prompt to a data extraction agent; and
extracting, by the data extraction agent, data from the data set according to instructions of the prompt.

9. The one or more non-transitory computer-readable media of claim 8, wherein the proxy agent, the prompt generation agent, the critic agent, and the data extraction agent are each large language model (LLM) agents.

10. The one or more non-transitory computer-readable media of claim 8, wherein the user input is a plain language input lacking syntax and formatting of the prompt.

11. The one or more non-transitory computer-readable media of claim 8, wherein determining the modifications to the prompt includes:
providing, by the proxy agent to a critic agent, the prompt;
analyzing, by the critic agent, the prompt to determine modification recommendations for the prompt; and
providing, by the critic agent to the proxy agent, the modification recommendations for the prompt.

12. The one or more non-transitory computer-readable media of claim 8, wherein determining the modifications to the prompt includes:
providing, by the proxy agent to the user, the prompt; and
receiving, by the proxy agent, the modification recommendations for the prompt.

13. The one or more non-transitory computer-readable media of claim 8, wherein executing the computer-executable instructions cause the one or more processors to perform acts comprising:
processing the extracted to manipulate the extracted data to form processed data; and
controlling a physical process according to the processed data.

14. The one or more non-transitory computer-readable media of claim 8, wherein the plurality of actions further comprises storing the extracted data in a data store.

15. A computer-implemented method, comprising:
receiving, at a proxy agent, user input from a user;
providing, by the proxy agent to a prompt generation agent, the user input;
generating, by the prompt generation agent, a prompt for querying a data set based on the user input;
providing, by the prompt generation agent to the proxy agent, the prompt;
determining modifications to the prompt;
modifying, by the prompt generation agent, the prompt according to the modifications to form a modified prompt;
providing, by the proxy agent, the modified prompt to a data extraction agent; and
extracting, by the data extraction agent, data from the data set according to instructions of the prompt.

16. The computer-implemented method of claim 15, wherein the proxy agent, the prompt generation agent, the critic agent, and the data extraction agent are each large language model (LLM) agents.

17. The computer-implemented method of claim 15, wherein the user input is a plain language input lacking syntax and formatting of the prompt.

18. The computer-implemented method of claim 15, wherein determining the modifications to the prompt includes:
providing, by the proxy agent to a critic agent, the prompt;
analyzing, by the critic agent, the prompt to determine modification recommendations for the prompt; and
providing, by the critic agent to the proxy agent, the modification recommendations for the prompt.

19. The computer-implemented method of claim 15, wherein determining the modifications to the prompt includes:
providing, by the proxy agent to the user, the prompt; and
receiving, by the proxy agent, the modification recommendations for the prompt.

20. The computer-implemented method of claim 15, further comprising:
processing the extracted to manipulate the extracted data to form processed data; and
controlling a physical process according to the processed data.
